(19) United States
(12) Patent Application Publication
(10) Pub. No.: US 2025/0264108 A1
(43) Pub. Date: Aug. 21, 2025

(54) CEILING FAN

(71) Applicant: Hunter Fan Company, Memphis, TN (US)

(72) Inventors: Charles William Botkin, Cordova, TN (US); Michael Paul Conti, Memphis, TN (US); Jason Matthew McPherson, Memphis, TN (US); Charles David McKee, Horn Lake, TN (US); Arvind G. Ramani, Collierville, TN (US); Douglas Troy Mason, Horn Lake, MS (US); Nicholas Dakota Vongprachanh, Memphis, TN (US)

(21) Appl. No.: 19/200,600

(22) Filed: May 6, 2025

Related U.S. Application Data
(63) Continuation-in-part of application No. 18/244,598, filed on Sep. 11, 2023.
(60) Provisional application No. 63/405,970, filed on Sep. 13, 2022.

(51) Int. Cl. F04D 25/08; F04D 19/00; F04D 25/06; F04D 29/056; F21V 33/00; F21Y 115/10

(52) U.S. Cl. CPC F04D 25/088; F04D 19/002; F04D 25/06; F04D 29/056; F21V 33/0096; F21Y 2115/10

(57) ABSTRACT

A ceiling fan includes a motor housing and a motor enclosed by the motor housing. A set of blades can extend from the motor housing and be operably coupled to the motor. The motor can include a rotor assembly and a stator assembly. The motor further includes a stationary motor shaft about which the rotor assembly rotates. A bearing rotatably supports the rotor assembly to the stationary motor shaft.

### CROSS-REFERENCE TO RELATED APPLICATION(S)

This application is a continuation in part of U.S. patent application Ser. No. 18/244,598, filed Sep. 11, 2023, which claims the benefit of U.S. Provisional Patent Application No. 63/405,970, filed Sep. 13, 2022, both of which are incorporated herein by reference in their entirety.

### TECHNICAL FIELD

This disclosure relates to the field of ceiling fans, and more specifically to low-profile ceiling fans and fan motors.

### BACKGROUND

Ceiling fans can include a set of fan blades rotatably coupled to a motor assembly to rotate the set of blades. Rotation of the fan blades drives a volume of fluid, typically ambient air, within a space for cooling or circulation. The fan blades can be rotatably driven by a centralized motor enclosed in a motor housing.

Typically, ceiling fans are mounted to an overhead surface by way of a downrod, housing, or the like. When assembled, the ceiling fan can be suspended within the area at appropriate distances from the overhead surface and the floor to provide for optimum spacing for driving air as well as overhead clearance with respect to occupants or items in the space below the fan.

### SUMMARY

In one aspect, the description relates to a ceiling fan comprising: a set of blades extending between a root and a tip; a motor assembly comprising: a stator assembly comprising a stationary motor shaft and a stator coupled to the stationary motor shaft, a rotor assembly comprising a rotor operably coupled to the root of the blades, and a bearing assembly having a single bearing rotationally coupling the stationary motor shaft to the rotor assembly.

### BRIEF DESCRIPTION OF THE DRAWINGS

In the drawings:

FIG. 1 is a bottom perspective view of a ceiling fan illustrating blades, a motor housing, and a light kit in accordance with various aspects described herein.

FIG. 2 is a top perspective view of the ceiling fan of FIG. 1.

FIG. 3 is a side view of the ceiling fan of FIG. 1.

FIG. 4 is an exploded view illustrating internal components of the ceiling fan of FIG. 1 including the motor housing and a motor in accordance with various aspects described herein.

FIG. 5 is an exploded view of the motor of FIG. 4 illustrating a pair of rotors and a stator in accordance with various aspects described herein.

FIG. 6 is a side cross-sectional view of another ceiling fan in accordance with various aspects described herein.

FIG. 7 is a perspective view of a portion of the ceiling fan of FIG. 6 illustrating a blade housing in accordance with various aspects described herein.

FIG. 8 is an exploded view illustrating internal components of the ceiling fan of FIG. 6 including a motor and blade mounts in accordance with various aspects described herein.

FIG. 9 is a perspective view of the blade mounts of FIG. 8.

FIG. 10 is a cross-sectional view of the motor of FIG. 8.

FIG. 11 is a perspective view of another ceiling fan illustrating another blade, motor housing, and light kit in accordance with various aspects described herein.

FIG. 12 is an exploded view illustrating internal components of the ceiling fan of FIG. 11 in accordance with various aspects described herein.

FIG. 13 is a cross-sectional view of an alternative low-profile motor similar to those of FIGS. 1 and 6.

FIG. 14 is a cross-sectional view of another alternative low-profile motor similar to those of FIGS. 1, 6, and 13.

FIG. 15 is a cross-sectional view of another alternative low-profile motor similar to those of FIGS. 1, 6, 13, and 14.

FIG. 16 is an exploded view of another alternative low-profile motor similar to those of FIGS. 1, 6, 13, and 14.

FIG. 17 is a cross-sectional view of the low-profile motor of FIG. 16.

FIG. 18 is a cross-sectional view of a low-profile motor with a storage recess.

FIG. 19 is a cross-sectional view of a variant of the low-profile motor of FIG. 19 without the storage recess, with a full length motor shaft, and still using a single bearing.

### DETAILED DESCRIPTION

The present disclosure generally relates to a low-profile or low-stack-height ceiling fan, as well as a ceiling fan motor. For example, low-profile fans are known for use in spaces where the ceiling or overhead surface is generally close to the floor, where a traditional ceiling fan may otherwise project into the space by an undesired amount. Any reduction in size for such fans may be limited based on internal components of the fan, such as the motor, controller, or light kit.

Aspects of the disclosure provide for an ultra-low-profile or ultra-low-stack-height ceiling fan, in some examples having a total height of between 1-3 inches. In some implementations, aspects of the disclosure provide for an ultra-low-stack-height fan that can be secured to a downrod and have a shortened or flattened visual appearance. Aspects further provide for an improved ceiling fan motor with a printed circuit board (PCB) stator assembly and magnetic-plate rotor assembly. Aspects further provide for an improved ceiling fan motor with a PCB rotor assembly and magnetic stator assembly. The ceiling fan motor can have an overall shorter or flattened profile, providing for a shorter or more flattened ceiling fan than typical fans in the art.

Electric motors are typically one of axial flux or radial flux. Axial flux motors have their magnetic flux lines parallel to the rotation axis, whereas radial flux motors have their magnetic flux lines radial/perpendicular to the rotation axis. Radial flux motors are historically more common. Axial flux motors have a higher power density than radial flux motors. The power density of an axial flux motor is often 30% or more than a similarly sized radial flux motor. However, axial flux motors have been disfavored because of their higher costs, especially when using laminations.

One form of an axial flux motor uses a printed circuit board (PCB) at the stator and the windings are formed by printed traces on the circuit board. These motors are referred to as PCB stator motors or just PCB motors. A PCB motor will typically have two rotors in the form of permanent magnets located both above and below the PCB stator. While one could get by with only one rotor, either above or below the stator, two rotors are often used because that configuration yields greater power (watts/horsepower) and takes advantage of the magnetic field emanating from both sides of the PCB stator.

Electric motors also can have either an internal rotor or an external rotor. For many ceiling fan applications, and external rotor is beneficial because the motor shaft is stationary and serves as a mounting point for the motor to a stationary object, like a ceiling or wall, via a downrod connecting the stationary drive shaft to the stationary object. Internal and external rotor configurations, especially in the ceiling fan art, result in different structural configurations, which does not always make it possible to transfer technology between the two configurations. For example, in the ceiling fan art, a light is often mounted to the ceiling fan. It is not desirable for the light to rotate and electricity must be supplied to the light and to electric motor. Given that the power supply is normally in the wall or ceiling, the downrod and stationary motor shaft are hollow and the light is mounted directly or indirectly to the stator/motor shaft, and the power cable is passed through the hollow interior of the downrod and the stationary motor shaft. The stator is mounted directly/indirectly to the stationary shaft while the rotor rotates relative to the shaft, and the blades are mounted to the rotor, not the shaft.

All directional references (e.g., radial, axial, proximal, distal, upper, lower, upward, downward, left, right, lateral, front, back, top, bottom, above, below, vertical, horizontal, clockwise, counterclockwise, upstream, downstream, forward, aft, etc.) are only used for identification purposes to aid the reader's understanding of the present disclosure, and do not create limitations, particularly as to the position, orientation, or use of aspects of the disclosure described herein. A generally downward direction can be defined as a direction that is directed more away from the ceiling or structure from which the ceiling fan suspends, than in a direction toward the ceiling. Connection references (e.g., attached, coupled, connected, and joined) are to be construed broadly and can include intermediate members between a collection of elements and relative movement between elements unless otherwise indicated. As such, connection references do not necessarily infer that two elements are directly connected and in fixed relation to one another. The exemplary drawings are for purposes of illustration only and the dimensions, positions, order and relative sizes reflected in the drawings attached hereto can vary. As used herein, the term “set” or a “set” of elements can be any number of elements, including only one.

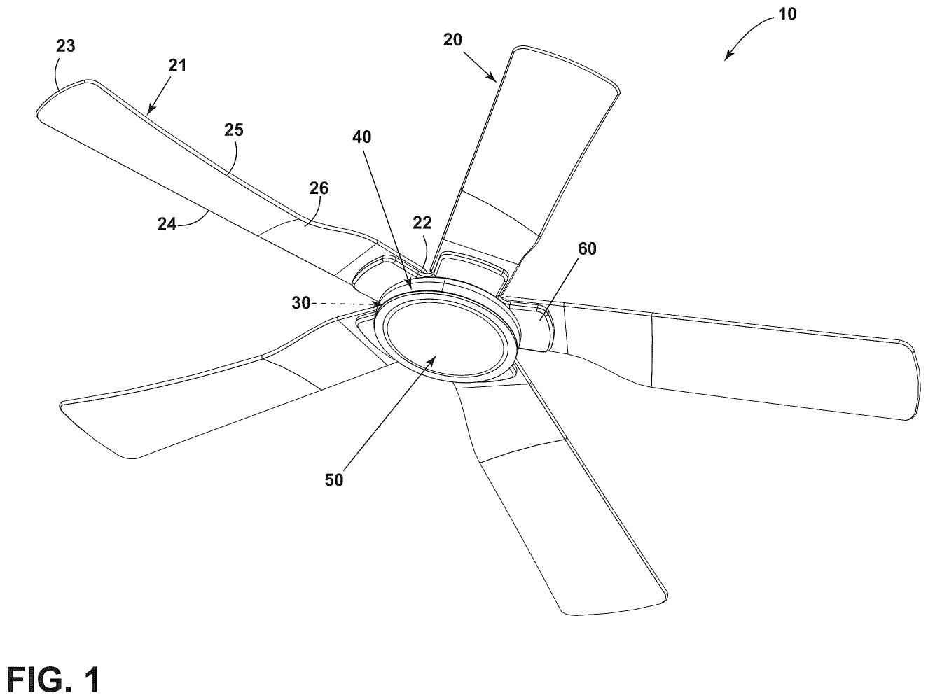

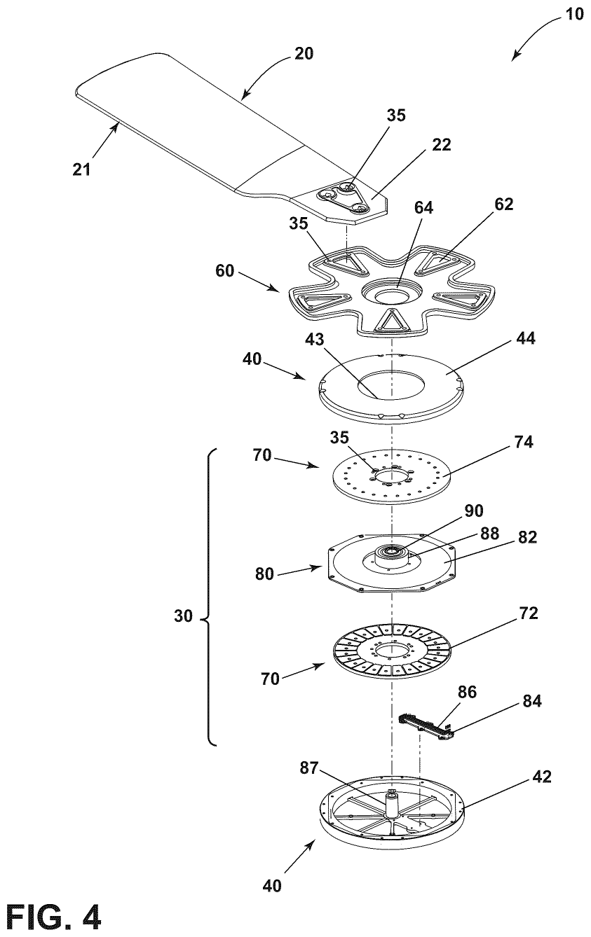

FIG. 1 illustrates a bottom perspective view of a ceiling fan 10. In the non-limiting example shown, the ceiling fan 10 includes a set of blades 20, a motor 30 (visible in FIG. 4), a motor housing 40, and optionally, a light kit 50. In non-limiting examples, the ceiling fan 10 can also include one or more of a controller, a wireless receiver, a ball mount, a hanger ball, a light glass, a light cage, a spindle, a finial, a switch housing, blade irons, blade forks, blade tips or blade caps, or the like. In addition, the ceiling fan 10 can be in the form of a low-profile fan having a short or flattened vertical profile. In some exemplary implementations, the ceiling fan 10 can be secured to a downrod and extend from an overhead surface. In some exemplary implementations, the ceiling fan 10 can be mounted directly to an overhead surface to form a low profile extending away from the overhead surface.

The set of blades 20 can extend radially from the ceiling fan 10 and can be rotatable to drive a volume of fluid such as air. While five blades are illustrated, the set of blades 20 can include any number of blades. A blade mount 60 can be provided for coupling the set of blades 20 to the motor 30. It is also contemplated that the set of blades 20 can be directly secured, fastened, coupled, or the like to the motor 30 without an intervening blade mount. The blade mount 60 can be attached (directly or indirectly) to or integrally formed with a rotor of the motor or motor housing.

A blade 21 in the set of blades 20 can include any suitable fan blade and extend between a root 22 and a tip 23 in a span-wise direction, and between a leading edge 24 and a trailing edge 25 in a chord-wise direction. In the example shown, the leading edge 24 can extend linearly outward from the motor housing 40, and the trailing edge 25 can include a vertical dip or scalloped portion 26 as shown. It can also be appreciated that a blade 21 can include any number of cross-sectional blade profiles and shapes to achieve the desired performance.

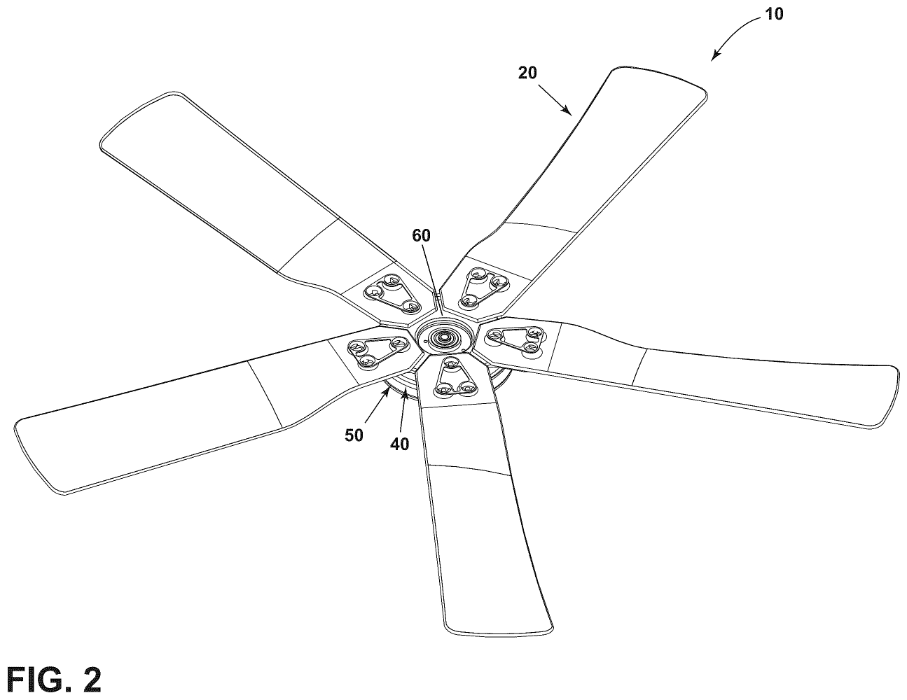

FIG. 2 illustrates a top perspective view of the ceiling fan 10 and illustrating one possible mounting of the blades. Mounting hardware such as bolts, screws, or the like can be provided for securing the set of blades 20 to the blade mount 60. The set of blades 20 and the blade mount 60 can be coupled to a top surface of the motor housing 40 and form an uppermost surface of the ceiling fan 10.

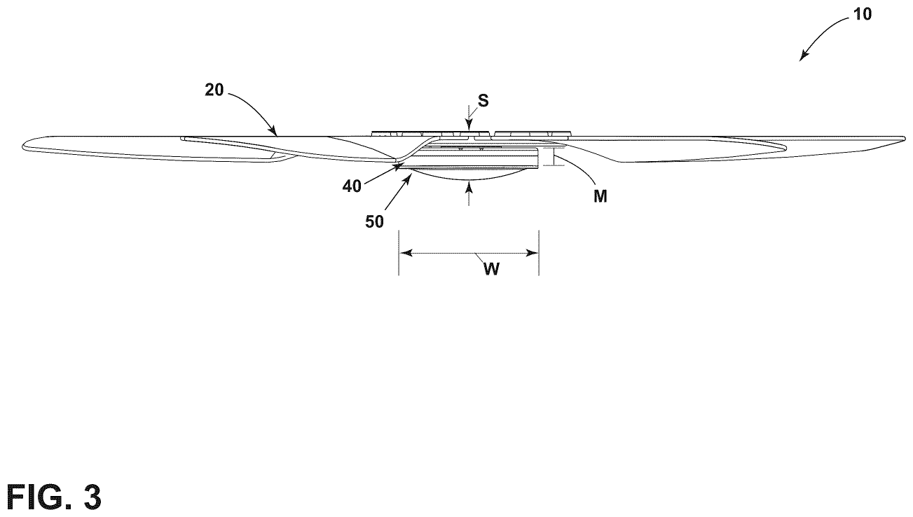

FIG. 3 illustrates a side view of the ceiling fan 10. A motor height (denoted “M”) can be defined as a vertical height of the motor housing 40. In a non-limiting example, the motor height M can be between 0.5-2 inches, including between 1-2 inches, including between 1.25-2 inches, in non-limiting examples. In addition, a stack height (denoted “S”) of the ceiling fan 10 can be defined as a total vertical height of the ceiling fan 10 including all components therein. It is contemplated that the stack height S can be between 0.5-5 inches, or between 0.5-4 inches, or between 1-3 inches, in non-limiting examples. In addition, a total width W of the motor housing 40 is indicated, which can also define a diameter of the motor housing 40. It is contemplated that the total width W can be between 2-10 inches, or between 4-9 inches, or between 6-7 inches, in non-limiting examples.

The light kit 50 can be secured to the motor housing 40 using any suitable coupling mechanism. In some implementations, the light kit 50 can be mounted by way of a spring-loaded connector, such as a pogo pin connector. In such a case, the spring-loaded connector can bias the engaged pin components and provide for a secure connection, counteracting any vibrational or oscillating motions at the connection point, during operation of the ceiling fan 10. The light kit 50 can also be connected by a snap-lock connection between the light kit 50 and the motor housing 40 or a bayonet-type rotational lock, for example.

Referring to FIG. 4, exploded views of the ceiling fan 10 are shown including a single blade, such as the blade 21, for visual clarity. The motor housing 40 can be in the form of a two-part housing and include a lower housing 42 and an upper housing 44 as shown. The blade mount 60 can be arranged above the upper housing 44, and the set of blades 20 can be arranged above the blade mount 60. In another example, the upper housing 44 can be omitted and the blade mount 60 can form a rotatable housing for the motor 30. Another way to think of this is that the blade mount 60 can be integrated with the upper housing 44. Other arrangements of the housing 40 and blade mount 60 are contemplated. The lower motor housing 42 is illustrated with a hub/spoke/rim configuration, with a stationary motor shaft 87 extending upward from the hub. A bearing assembly can be located within the hub and rotation couple to the motor shaft. The motor 30 defines an outer periphery, which defines the exterior of the motor. As illustrated the upper and lower housings 44, 42 collectively define the outer periphery.

The motor height, M, is the greatest vertical dimension between the outer surfaces of the upper and lower housings 40. In some motors, the housings does not necessarily conform to the shape of the rotor/stator and are more ornate. In the motor 30, the housings 40 do conform more to the shape of the rotor/stator to reduce the overall height of the motor.

The motor 30 can be enclosed by the motor housing 40. The motor 30 can be in the form of an axial flux, permanent magnet motor including a rotor assembly 70 and a stator assembly 80. The rotor assembly 70 can include a lower rotor 72 and an upper rotor 74. The stator assembly 80 can include a PCB stator 82, bearing assembly 90 located in a central hub or collar 88. The motor shaft 87 can carry the bearing assembly 90 and support part of the PCB stator 82. An arm 84 carrying a set of electrical components 86 can be supported by the lower housing 42.

The set of electrical components 86 can include wired or wireless connections between components of the ceiling fan 10. In the illustrated example the set of electrical components 86 includes multiple wires extending through the arm 84, such as for providing power to the light kit 50 (FIG. 3) in a non-limiting example. Any number of rotors and stators can be provided in the motor 30. For instance, an alternating-stack arrangement can be formed such as a rotor-PCB stator-rotor-PCB stator-rotor-PCB stator-rotor arrangement, in one non-limiting example.

It is contemplated that the blade mount 60 can be in the form of a singular component with multiple coupling portions 62 configured to couple to corresponding blades in the set of blades 20. The blade mount 60 can also be secured to a portion of the rotor assembly 70, such as the upper rotor 74, for driving the set of blades 20. In the example shown, the blade mount 60 includes a central recess 64. Mounts 35 can be provided in any or all of the blades 21, coupling portions 62, or the upper rotor 74. Such mounts 35 can include apertures, fasteners, snap-fit connectors, dovetail connectors, or the like. The blade 21 can be coupled to the coupling portion 62 by way of the mounts 35. In addition, the central recess 64 of the blade mount 60 can extend through an opening 43 in the upper motor housing 42 and be coupled to the upper rotor 74 by way of the mounts 35. In this manner, the set of blades 20 and the blade mount 60 can be secured to and co-rotate with the upper rotor 74. In another non-limiting example, the set of blades 20 and blade mount 60 can be coupled to the lower rotor 72, such that the motor housing 40 is positioned above the set of blades 20. In such a case, it is understood that components or arrangements of the motor 30 and motor housing 40 can be modified, inverted, or the like to provide for coupling the set of blades 20 to the lower rotor 72. It is also possible to couple the blades to both the upper and lower motor housings 42, 44. It is also contemplated that the upper and lower rotors 74, 72 can be configured so as to perform the role of the housing 40, negating the need for any housing 40, and the blades would be directly/indirectly mounted to one or both of the upper and lower rotors 74, 72.

The blade mount 60 being on top of the upper housing 44 increases the stack height, S, of the motor, resulting in the stack height, S, being greater than the motor height, M. The additional of the blades 20 mounting to the top of the blade mount 60 further increases the stack height, H.

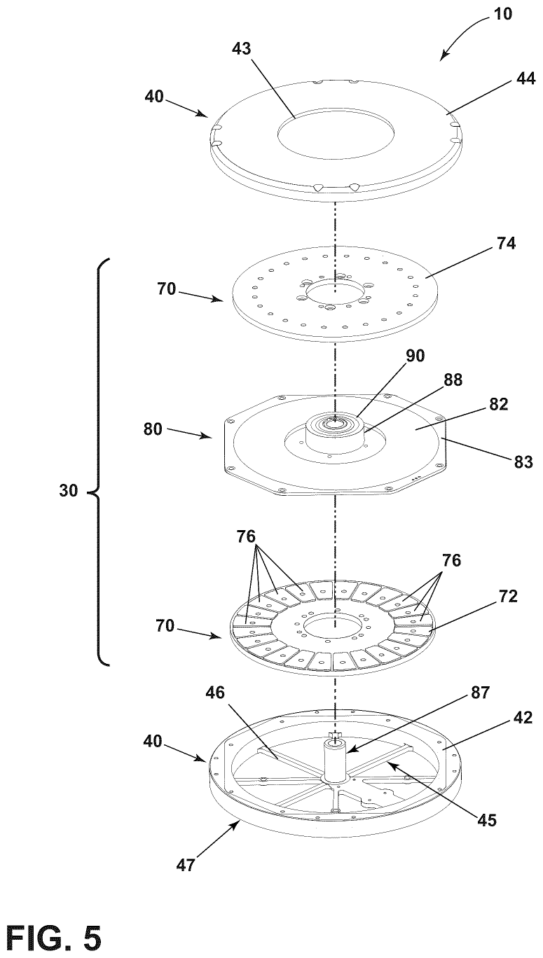

FIG. 5 illustrates the motor 30 and motor housing 40 in further detail. The upper rotor 74 and the lower rotor 72 can include a corresponding set of permanent magnets 76, each of which defines a magnetic pole. The PCB stator 82 can be positioned centrally between the upper and lower rotors 72, 74. The PCB stator 82 can have a portion 83 extending radially beyond the upper rotor 74 or the lower rotor 72 as shown. The portion 83 can form a mounting fixture point to the motor housing 40, such as the lower housing 42 or the upper housing 44. While the PCB stator 82 is shown sandwiched between two rotors 74, 72, it is contemplated that a single rotor can be used.

It is further contemplated that the motor housing 40 can form a heat sink 46 for the motor 30. As shown, the heat sink 46 is provided with the lower housing 42 of the motor housing 40 though this need not be the case. The heat sink is in the form of a hub 43, spoke 45, and rim 47, with the hub 43 having the motor shaft 87, which can support the PCB stator 82, thereby thermally conductively coupling to the PCB stator 80. In this way, a thermal conductive path is formed from the PCB stator 80, to the shaft 87, to the hub 43, to the spokes 45, and to the rim 47. Another thermal conductive path is created by the outer periphery of the PCB stator 80 resting on the rim 47. Heat from the PCB stator 80 can transfer along either or both conductive paths where it can be dissipated by radiation and/or convection to the surrounding environment. The spokes 45 can be replaced with a sheet and/or there can be added fins or other suitable cooling structures.

One or more heat sinks can be provided with the upper housing 44 or the lower housing 42. In some implementations, the motor housing 40 can be formed of thermally conductive materials such that heat can be distributed through all portions of the housing 40. In some implementations, the motor housing 40 can include thermally conductive materials for at least the heat sink 46 and can also include thermally insulating materials in other portions of the housing 40, such as the upper housing 44. In this manner, heat generated within the motor 30 during operation can be selectively directed to at least the heat sink 46 and dissipated into the surrounding environment.

Referring generally to FIGS. 1-5, during operation of the ceiling fan 10, the upper rotor 74 and lower rotor 72 can rotate with the collar 88 with respect to the stationary PCB stator 82. The set of blades 20 can be driven by and co-rotate with the upper rotor 74 by way of the blade mount 60 as described above. The leading edge 24 of each blade in the set of blades 20 can direct adjacent air over the corresponding scalloped portion 26 such that air flows downward with rotation of the set of blades 20. In this manner, the ceiling fan 10 can operate with an ultra-low profile formed by a very small stack height S as described above.

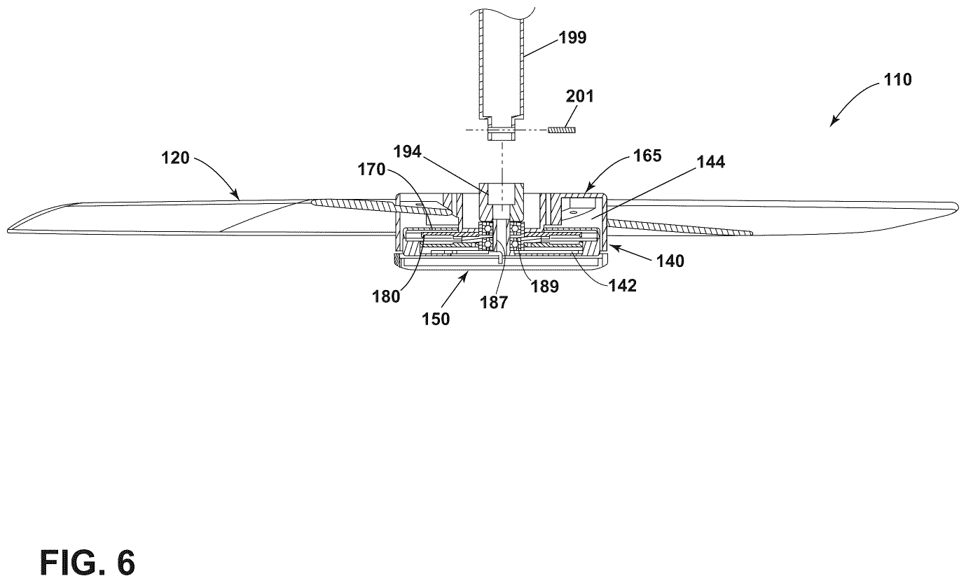

Turning to FIG. 6, another ceiling fan 110 is illustrated in accordance with various aspects described herein. The ceiling fan 110 is similar to the ceiling fan 10; therefore, like parts will be identified with like numerals beginning with 100, with it being understood that the description of the like parts of the ceiling fan 10 applies to the ceiling fan 110, unless otherwise noted.

The ceiling fan 110 is illustrated in a side sectional view and includes a set of blades 120, a motor housing 140, and a light kit 150. One difference compared to the ceiling fan 10 is that the ceiling fan 110 can include a rotatable blade housing 165. The blade housing 165 can receive the set of blades 120 and form an outer cover over the motor housing 140. The rotatable blade housing 165 is attached to the upper rotor 74 in a manner similar to how the blade mount 60 passes through the opening 43 of the upper housing 44 and attaches to the mounts 35. In this way, the upper housing 44 is stationary while the upper rotor 74 rotates to rotate the blade housing 165 and the blades 120 attached to the rotatable housing. In some examples, the blade housing 165 can be a unitary, one-piece housing receiving that receives the set of blades 120. When assembled, the set of blades 120 can be vertically spaced from the motor housing 140 as shown. The light kit 150 can be integrated with the lower housing 42 or attach to the lower housing 42. The mounting of the light kit 150 to the lower housing 42 means the light kit 150 does not rotate.

A motor adapter 194 is shown attached to a stationary motor shaft 187. The motor adapter 194 is mounted to a downrod 199. The downrod 199 and motor adapter 194 can have complementary threads such that the downrod 199 is threaded into the motor adapter 194. Alternatively, the downrod 199 can be received within the motor adapter 194 and a pin is then passed through aligned openings in the downrod 199 and motor adapter 194 in the traditional manner.

The blade housing 165 extends above the upper housing 144 resulting in the blade housing 165 increasing the stack height, S, and making the stack height, S, greater than the motor height, M.

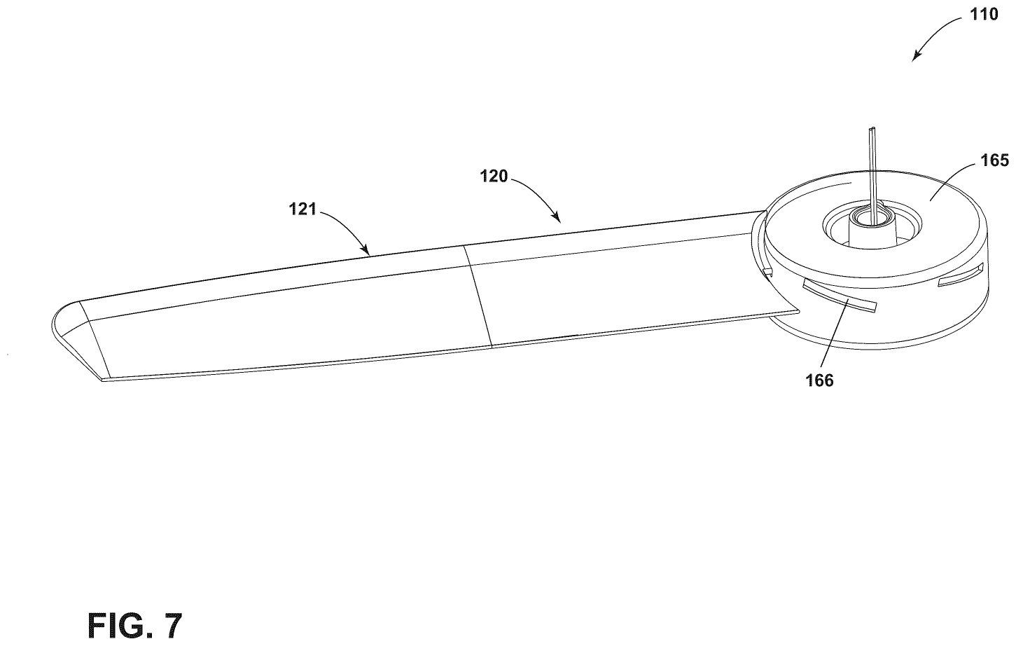

FIG. 7 illustrates a perspective view of the ceiling fan 110. For clarity, one blade 121 in the set of blades 120 is shown. Any number of blades can be provided in the set of blades 120. The blade housing 165 can also include slots 166 through which the set of blades 120 can extend. Electrical wires 167 are shown extending into the stationary motor shaft. The electrical wires can supply power or communication to the motor 130.

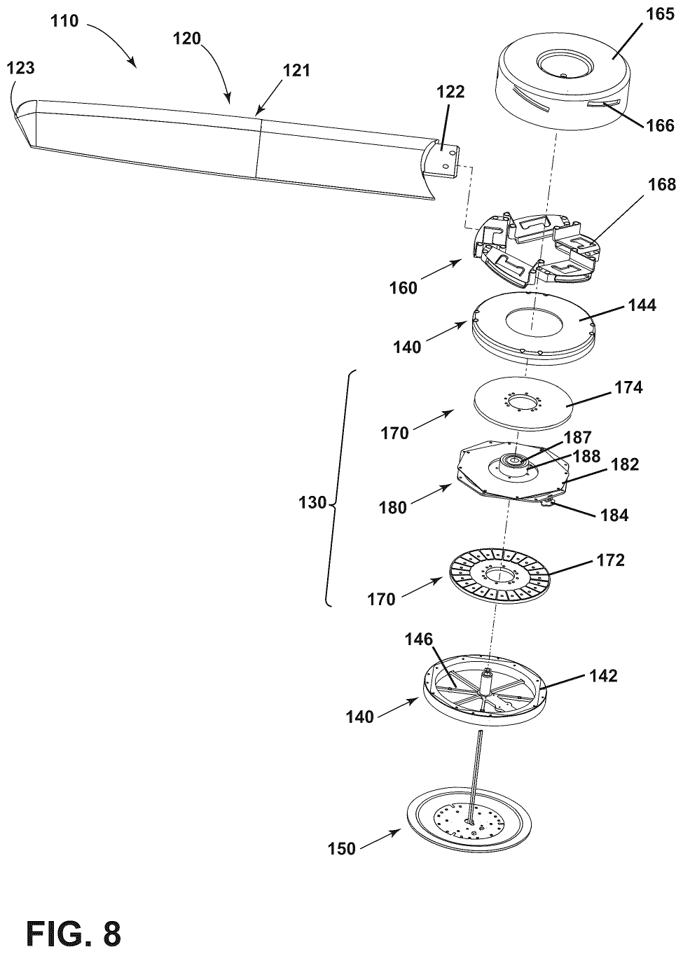

Turning to FIG. 8, an exploded view of the ceiling fan 110 illustrates the blade housing 165, the blade 121, the motor housing 140, and the light kit 150 in a stacked arrangement. The blade 121 can extend between a root 122 and a tip 123 as shown.

The motor housing 140 can include a lower housing 142 and an upper housing 144 as shown. The motor 130 can include a rotor assembly 170 and a stator assembly 180. The rotor assembly 170 can include a lower rotor 172, an upper rotor 174, and a set of magnets 176 coupled to the lower and upper rotors 172, 174. The stator assembly 180 can include a PCB stator 182, a central shaft 187, and a collar or central hub 188. When assembled, the set of magnets 176 can confront the PCB stator 182 from each of the lower and upper rotors 172, 174

A heat sink 146 can be provided in the ceiling fan 110. The heat sink 146 can be provided with either or both of the lower housing 142 or the upper housing 144. In the example shown, the heat sink 146 is provided with the lower housing 142. In some examples, the lower housing 142 can define the heat sink 146 as a unitary component. In some examples, the heat sink 146 can be a separate component and coupled to the lower housing 142.

When assembled, the PCB stator 182 can be positioned between the lower rotor 172 and the upper rotor 174. The lower housing 142 and upper housing 144 can enclose the rotor assembly 170 and the stator assembly 180. The blade mount 160 can be positioned above the upper housing 142. The blade housing 165 can enclose the blade mount 160 and the motor housing 140. The light kit 150 can be positioned below and adjacent the blade housing 165. In this manner, the blade housing 165 can form an uppermost surface of the ceiling fan 110, and the light kit 150 can form a lowermost surface of the ceiling fan 110. In an example where no light kit is provided, it is appreciated that the lower housing 142 can form a lowermost surface of the ceiling fan 110.

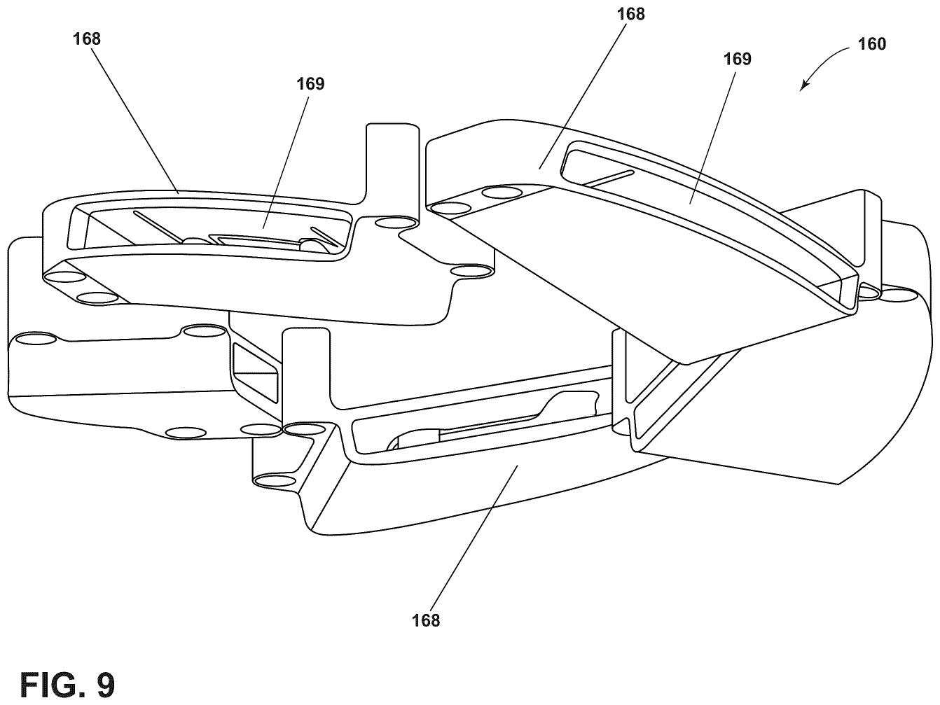

Another difference compared to the ceiling fan 10 is that the blade mount 165 can be in the form of multiple individual mounts 168 coupled to the blade housing 165. Turning to FIG. 9, the mounts 168 are shown in further detail. Each mount 168 can include a pocket 169 configured to receive the root 122 of each blade 121 (FIG. 7). Still another difference is that the mount 168 can form a snap-fit connection with the root 122 (FIG. 7). For example, the mount 168 can include interior projections configured to snap onto a recess on the blade root 122 (FIG. 7). Such a snap-fit connection can provide for improved assembly or removal of the set of blades 120 (FIG. 7). It is contemplated that the snap-fit connection can fully secure the set of blades 120 to the mounts 168 without need of additional threaded fasteners. Additionally or alternatively, fasteners can be provided in combination with the snap-fit connection.

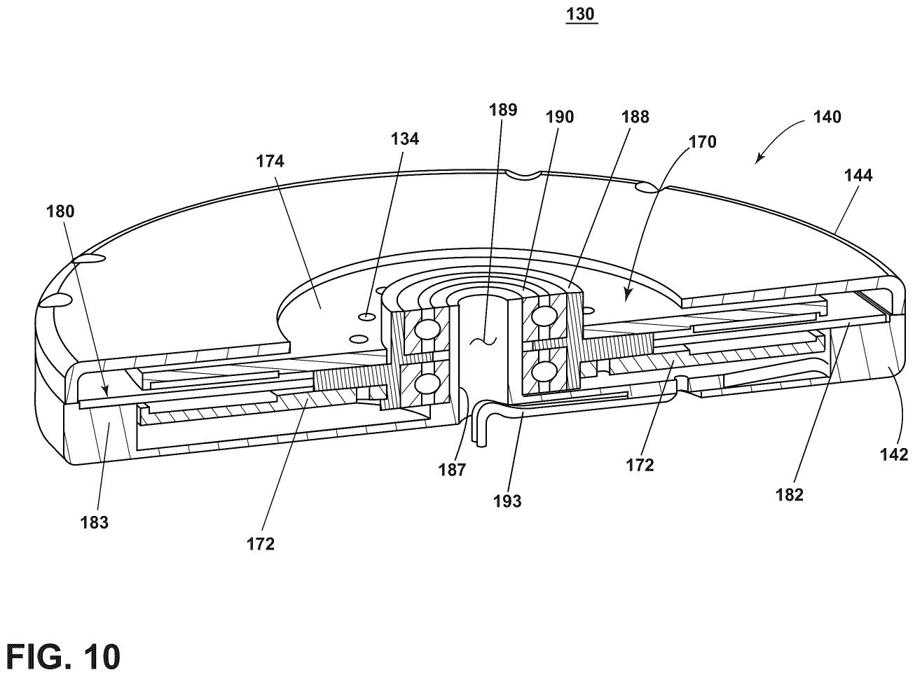

FIG. 10 illustrates a cross-sectional view of the motor 130. The motor 130 can include a set of apertures 134 in either of the lower rotor 172 or the upper rotor 174. In the example shown, the set of apertures 134 is provided with the upper rotor 174. The set of apertures 134 can be configured to directly or indirectly couple to each mount 168 (FIG. 9), such as by way of a suitable fastener, like a threaded bolt. For example, the set of apertures 134 can provide for coupling the rotor assembly 170 to the blade housing 165, and the blade housing 165 can be secured, fastened, or the like to each mount 168. In this manner, rotation of the rotor assembly 170 can drive rotation of the set of blades 120. The set of apertures 134 can be threaded or tapped to receive suitable fasteners. Electrical wires 193 can supply power or data to the motor 130 and/or a light kit.

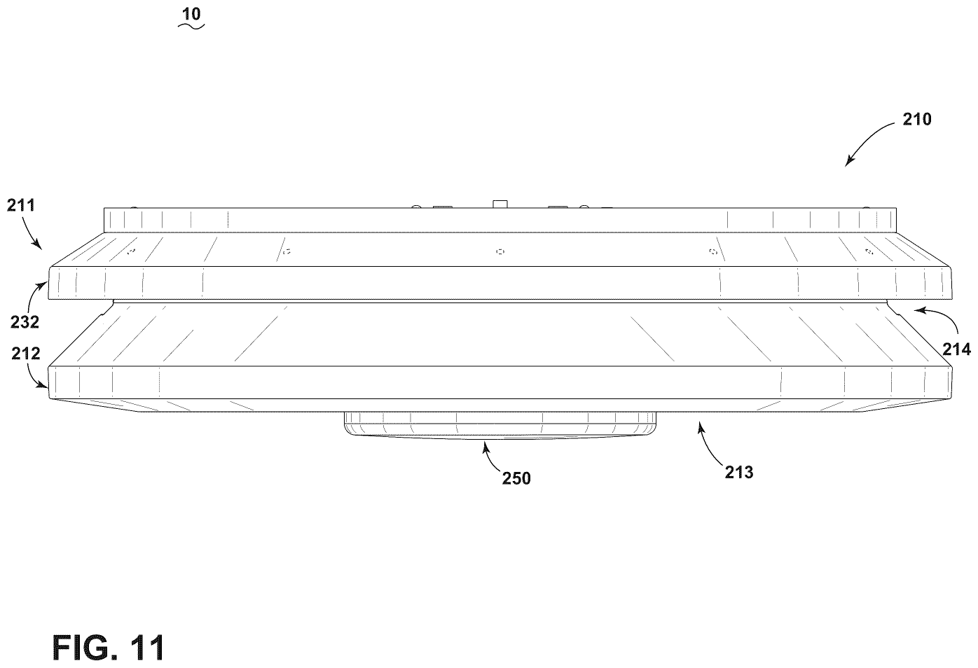

Referring now to FIG. 11, another ceiling fan 210 is illustrated in accordance with various aspects described herein. The ceiling fan 210 is similar to the ceilings fan 10 and 110; therefore, like parts will be identified with like numerals beginning with 200, with it being understood that the description of the like parts of the ceiling fans 10 and 110 applies to the ceiling fan 210, unless otherwise noted.

The ceiling fan 210 can be in the form of an impeller fan with a body 211 that includes an inlet housing 212 and a deflector 232. In the non-limiting example shown, the inlet housing 212 and the deflector 232 can each have an annular shape. The inlet housing 212 can define an inlet 213 for drawing airflow into the body 211. An outlet 214 can be provided on one side of the body 211. The deflector 232 can be moveable relative to the inlet housing 212. More specifically, the deflector 232 can be movable relative to the outlet 214 to control the direction of the air emitted through the outlet 214.

A light kit 250 can be carried by the body 211 in some exemplary implementations. For instance, the light kit 250 can be suspended from the inlet housing 212. In one example, a controller (not shown) can be provided within the inlet housing 212, which can be utilized for controlling or operating the ceiling fan 210. In alternative non-limiting examples, a controller can be provided remote from the ceiling fan 210, such as a wall-mounted controller or a wireless controller.

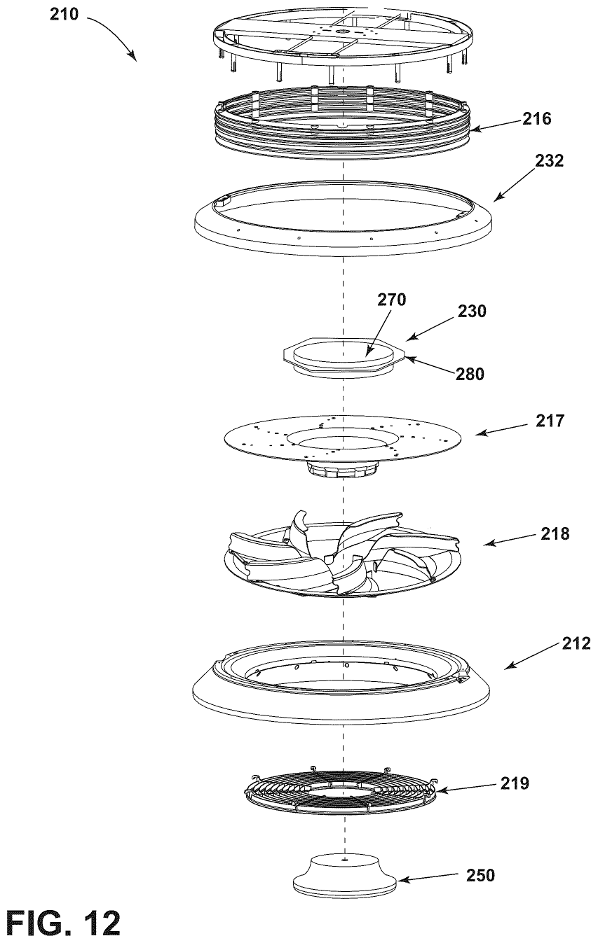

Turning to FIG. 12, the major components of the ceiling fan 210 can be seen in a partially exploded view and include, in stacked arrangement, an outlet frame 215, a set of guide vanes 216, the deflector 232, a motor 230, a shroud 217, an impeller 218, the inlet housing 212, an optional inlet grill 219, and the light kit 250.

The outlet frame 215 can be configured to secure the body 211 to a structure, such as a ceiling. The set of guide vanes 216 can include spaced, stationary foils, louvers, airfoils, or the like. In the example shown, the set of guide vanes 216 includes a set of louvers in the form of vertically stacked, slanted rings. The deflector 232 can be movable relative to the inlet housing 212 to form variable flow angles for air exiting the outlet 214 (FIG. 11). The impeller 218 includes a set of blades mounted to an outer ring and configured to draw air into the inlet 213 (FIG. 11).

The motor 230 can drive rotation of the impeller 218. The motor 230 is similar to the motor 30, 130 and can include a rotor assembly 270 having a lower rotor 272 and an upper rotor 274, as well as a stator assembly 280 including a PCB stator 282 as shown.

The rotor assembly 270 can couple to a portion of the shroud 217 to effect rotation of the shroud 217. Since the impeller 218 is mounted to the shroud 217, rotation of the shroud 217 effects rotation of the impeller 218.

Referring generally to FIGS. 11-12, during operation, air is drawn into the inlet 213 by the impeller 218. Depending on a relative positioning of the deflector 232 and the inlet housing 212, air can exit through the outlet 214 with a variable exit angle to form various exit air flows, including a generally horizontal air curtain adjacent the body 211, or a downward air flow away from the body 211, in non-limiting examples.

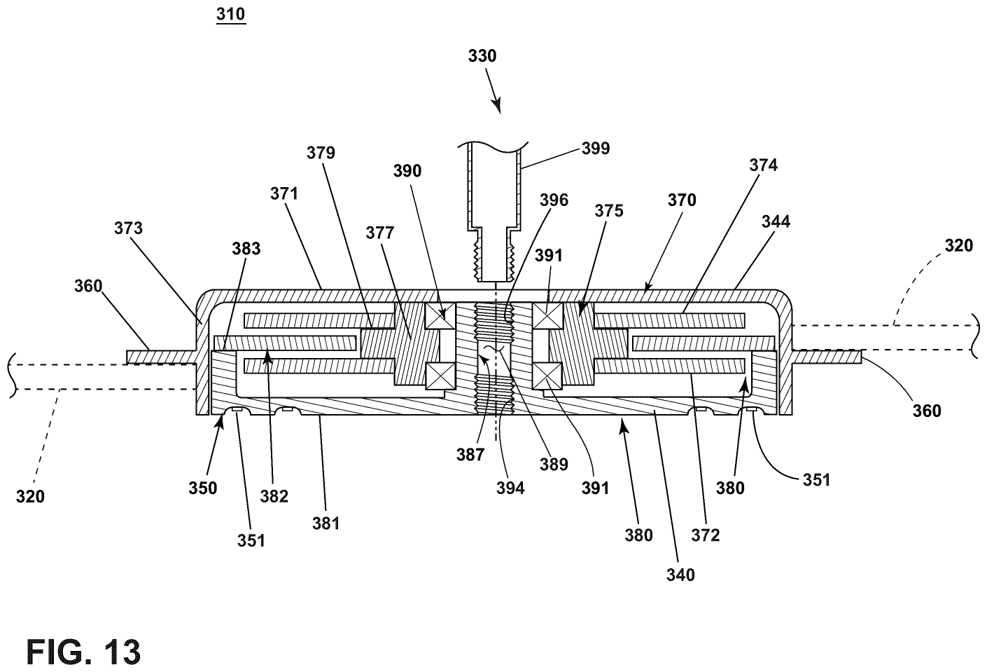

FIG. 13 illustrates a cross-sectional view of an alternative ceiling fan 310, with a DC, axial flux, ceiling fan motor 330, which is generally similar to the prior ceiling fan motors 30, 130, and 230. Therefore, like parts will be identified with like numerals beginning with 300, with it being understood that the description of the like parts of the ceiling fans 10, 110, 210 applies to the ceiling fan 310, unless otherwise noted. The ceiling fan motor 330 differs from the motors 30, 130 in that blade mounts are integrated with the rotor. Also, the upper and lower housings are now integrated with the rotor and stator assemblies, negating the need for a separate housing to cover the rotor and stator.

More specifically, the motor 330 has a stator assembly 380 and a rotor assembly 370 rotationally mounted to the stator assembly 380 by a bearing assembly 390. The stator assembly 380 includes a PCB stator 382 carried by a stator or lower housing 340. A motor shaft 387 projects upwardly from the lower housing 340. The bearing assembly 390 has as pair of spaced bearings 391 that rotationally couple the rotor assembly 370 to the motor shaft 387. Blade mounts 360 extend from the rotor assembly 370 and mount the blades 320.

Looking in more detail at the stator assembly 380, the lower housing 340 is illustrated as a lower wall 381 with a rim 383 on which the PCB stator 382 rests or seats. It is contemplated that the lower wall 381 is in the form of a disk and the rim 383 is an annular ring. However, the lower wall 381 need not be a wall, let alone a solid wall, and it can have many pass-through openings, which can advantageously be used for heat transfer. Alternatively, instead of a wall with openings, a hub/spoke/rim configuration could be used where the lower wall 381 is in the form of a hub and spoke, with the rim 383 forming the rim of the hub/spoke/rim arrangement. The shaft 387 could be mounted to the hub in this configuration. The lower wall 381 also need not be planar. It can be concave, convex or have any other desired cross-sectional shape. Whatever the form and cross-sectional shape of the lower wall 381, it will have an outer surface with an uppermost point and a lowermost point, which can be the same point or different points.

The shaft 387 can be integrally formed with the lower wall 381, separate from the lower wall 381, or attached to the lower wall 381. For example, the shaft 387 can be pressed-fit into an opening in the lower wall 381 or threaded into a tapped opening in the lower wall 381. The shaft 387 can have a hollow interior 389 through which other elements of the fan may pass, such as electrical wiring, for power and/or data, and connectors.

The rotor assembly 370 comprises a rotor or upper housing 344 with an upper wall 371 from which extends a peripheral wall 373. The size of the upper wall 371 is illustrated being great enough such that the peripheral wall 373 lies radially beyond the lower wall 381 and rim 383. The peripheral wall 373 is illustrated as extending down to the lower surface of the lower wall 381 to provide a flush or continuous transition from the upper wall 371 to the peripheral wall 373. The peripheral wall 373 need not terminate flush with the lower surface of the upper wall 371. The peripheral wall 373 can extend beyond the upper wall 371 or may just partially overlap with at least one or both of the lower wall 381 and rim 383 to at least partially hide them from view. Regardless of the extent of the peripheral wall 373, the upper wall 371, peripheral wall 373, and the lower wall 381 visually form an exterior of the motor 330 and the entire fan.

The rotor assembly 370 further includes sets of permanent magnets 372, 374 with one of the sets 372 located below the PCB stator 382 and the other set 374 located above the PCB stator 382. The rotor assembly 370 includes a carriage 375 for securing the sets of permanent magnets 372, 374. The carriage 375 is illustrated as having a collar 377 depending from the upper wall 371 with an annular spacer 379 separating the sets of permanent magnets 372, 374, which are illustrated as disks, but need not be. The spacer 379 is aligned with and thicker than the PCB stator 382 to affect a vertical spacing of the sets of permanent magnets 372, 374 relative to the PCB stator 382. The spacer 379 is illustrated integrally formed with the collar 377, but it can be a separate piece, such as a snap-ring or multiple snap rings that rest in one or more grooves in the collar 377. The relative spacing of the rim 383 and spacer 379 controls the relative, vertical proximity of the sets of permanent magnets 372, 374 and the PCB stator 382.

While two sets of permanent magnets are shown, it is contemplated only one be used. When a single set of permanent magnets is used, the set of permanent magnets could be mounted directly to or set up against the interior surface of the upper wall 371, which would provide a more vertically compact arrangement, reducing the motor height, H, and the corresponding stack height, S. The mounting of the set of permanent magnets to or against the interior surface could also be used in the case of multiple sets of permanent magnets. For example, the spacer 379 could be moved closer to the upper wall 371 so as to force the set of permanent magnets into abutment with the interior surface of the upper wall 371.

While only one combination of PCB stator 382 and corresponding sets of permanent magnets 372, 374 are shown, multiple sets could be used in a stacked arrangement, with or without a set of permanent magnets being shared between adjacent PCB stators, which is applicable to all the described motors. While stacking multiple PCB stators and corresponding magnets can be used for a variety of purposes, it is suitable for controlling the diameter of the motor housing, yet increasing the motor torque, while sacrificing stack height.

The bearing assembly 390 is illustrated as being integrated with the carriage 375 in that the spacer 379 lies on both the interior and exterior of the collar 377. However, the bearing assembly 390 can be separate from the carriage and even separate from the rotor assembly 370. The bearing assembly 390 can just as easily be integrated or affixed to the motor shaft 387. Similarly, the stator assembly 380 can have at least one bearing seat for holding at least one of the bearings 391.

The blade mounts 360 can be integrally formed with or affixed to the peripheral wall 373. One possible implementation is that the rotor assembly 370 is cast, injection molded, or 3-D printed as a single piece. The blade mounts 360 can have openings to receive fasteners, such as bolts, screws, grommets, etc., to secure the blades 320 to the blade mounts 360. The blade mounts 360 can be ramps oriented at an angle to provide the blade with an angle of attack. The angle of the ramps can be thought of as the pitch of the ramps relative to the axis of rotation of the rotor assembly 370. The blade mounts 360 can be such that the blades 320 can be mounted to either side of the blade mounts 360. In FIG. 13, one of the blades 320 is shown mounted to the top of the blade mount and another blade 320 is alternatively mounted to a bottom of the blade mount. Alternatively, the blade mounts 360 could slidably receive the blades and/or the blades could slide over the blade mounts 360. While the blade mounts 360 are shown as ramps, they could just as easily be the slots and blade attachments as shown in FIG. 6 by making room within the rotor assembly 370 for the slots and the corresponding blade attachment.

The blade mounts 360 are illustrated extending from the peripheral wall 373. To obtain the shortest stack height, S, the blade mounts would be located along the peripheral wall between the outer surface of the upper wall 371 and the outer surface of the lower wall 381. The blade mounts can also reside within the vertical extent of the rotor magnets and the stator coils. Optionally, the blade mounts can be located on the outer surfaces of one or both of the upper wall 371 and lower wall 381. The blade mounts 360 can be located along the peripheral wall 373 with the shape of the blade 320 in mind to ensure that during non-rotation, rotation, or both, of the blades 320, the blades remain within the motor height, M.

Optionally, a light kit 350 is provided with the stator assembly 380. The light kit 350 is illustrated as a plurality of LEDs 351 that are provided in the lower wall 381 and arranged as one or more concentric rings of LEDs. However, the LEDs 351 need not be provided in the lower wall 381 or arranged in rings. The LEDs could be mounted to the lower wall 381 and they could be in any desired pattern or randomly arranged. The LEDs 351 could have their own frame, housing, or similar structure that is affixed to the stator assembly 380. The light kit could, alternatively, be integrated in the upper wall 371. Although LEDs are the described light source, any suitable illumination source can be used.

An integrated motor adapter 394 is provided with the stator assembly 380. The motor adapter 394 can mount to a traditional downrod or ceiling bracket to secure the motor 330 to a structure, like a wall or ceiling. The motor adapter 394 is illustrated as the hollow interior 389 being tapped or threaded 396. A complementary downrod 399 has cooperating threads to be threaded into the threads 396. The direction of the threads 396 would be coordinated with the direction of rotation of the blades 320 to prevent an unthreading of the motor adapter 394 and downrod during normal use. Additionally, an anti-rotation device, such as spring-biased detent, could be provided between the motor adapter 394 and the downrod to prevent anti-rotation after the initial threading. While the threads are shown as internal threads, they could be externally located, with downrod thus having internal threads.

Motor adapter aside, the motor 330 can be mounted to any suitable surface using any one of the traditional downrod approaches. In such a configuration, a downrod would extend from the ceiling and be secured to the stationary motor shaft 387 in any suitable manner. Alternatively, a bracket, without a downrod, could secure the motor shaft 387 to the structure. In a “flipped” orientation from what is seen in FIG. 13, the stator assembly 380, instead of the rotor assembly 370, could face the structure, such as a ceiling, and the stator assembly 380 be secured to the structure either directly or indirectly with a bracket.

The integrated motor adapter 394 reduces the stack height, S, over traditional ceiling fans, where the motor adapter is affixed to the end of the stationary motor shaft 387 and would extend above the upper motor housing 344. The motor adapter 394 resides at least partially within the vertical extent of at least one of the magnets for the rotor and the coils of the stator, and the upper and lower surfaces of the lower and upper housings 342, 344, which yields an extremely compact, low-profile motor. The motor adapter 394 can be used on any of the described motors.

A heat conductive pathway is formed by the PCB stator 382 being in contact with the rim 383. In this way, heat from the PCB stator is transferred to the lower wall 381 of the stator housing 340. Heat dissipation structures, such as fins or the like, can be provided on the lower wall 381, especially the exterior surface of the lower wall 381, to aid in transfer of the conducted heat to the surrounding environment. Additionally, since the upper wall 371 and/or the spacer 379 are in contact with the motor shaft 387, as second heat conductive path is formed from the PCB stator 382 to the upper wall 371 via the rim 383, lower wall 381, motor shaft 387 and, optionally, the spacer 379 of the carriage.

The configuration of the motor 330 provides a very low-profile motor for several reasons. First, the housing 340 is formed by or integral with the rotor assembly 370 and stator assembly 380, which negates the need for a separate housing. Such a separate housing will typically increase the stack height, S, of the fan 310. Second, the blade mounts 360 are located between the upper wall 371 and the lower wall 381 of the rotor assembly 370 and stator assembly 380, respectively. The location of the blade mounts 360 along the peripheral wall 373 and the shape of the blades 320 can be coordinated so that the blades 320 reside entirely within the height M of the motor, which further reduces the stack height, S, to the motor height, M. Third, the light kit 350 being integrated within the lower wall 381 also locates the light kit 350 within the height M of the motor. Fourth, the motor adapter 394 being integrated with the housing 340 and/or at least partially within the vertical extent of the rotor assembly 370 and stator assembly 380, further reduces the stack height, S, as motor adapters are typically located above the magnets/coils of the rotor/stator and above the motor housing 340. Fifth, integrating the light kit 350 into the stator or lower housing 342 also further reduces the stack height, especially since light kits are normally affixed to and depend on the stator housing.

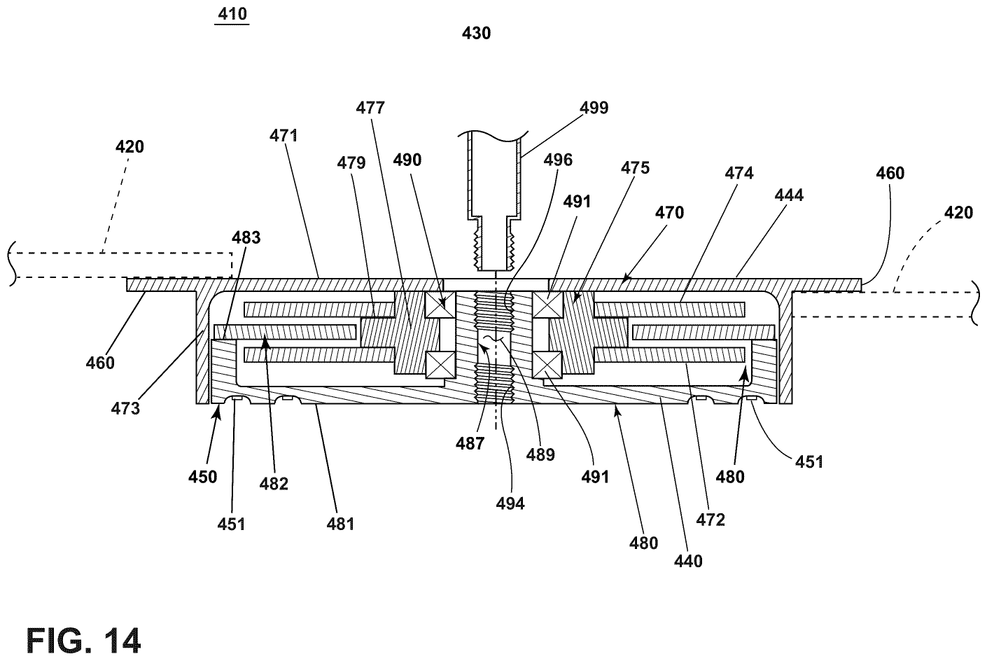

FIG. 14 illustrates a ceiling fan 410 with a motor 430, which is a variant of the motor 330, and mounts the blades to the top of the rotor housing. The ceiling fan 410 is similar to the ceiling fans 10, 110, 210, and 310; therefore, like parts will be identified with like numerals beginning with 400, with it being understood that the description of the like parts of the ceiling fan 10, 110, 210 and 310 applies to the ceiling fan 410, unless otherwise noted. The motor 430 is essentially the same as the motor 330, except that the blade mounts 460 have been moved to the top of the peripheral wall 473. The blades 420 can be mounted to either side of the blade mounts 460 and/or the blade mounts 460 can slidably receive the blade or be slidably received within the blade. The blade mounts 460 are illustrated as planar extensions from the upper wall 471. Thus, the blade mounts 460 can be formed by making a wider or greater diameter upper wall 471 that overhangs the peripheral wall 473. Alternatively, the blade mounts 460 can be discretely located at the desired locations providing the upper wall 471 with a castellated appearance when viewed from above. It also contemplated that the blades 420 could be mounted directly to the upper wall 471, negating the need for a dedicated blade mount 460.

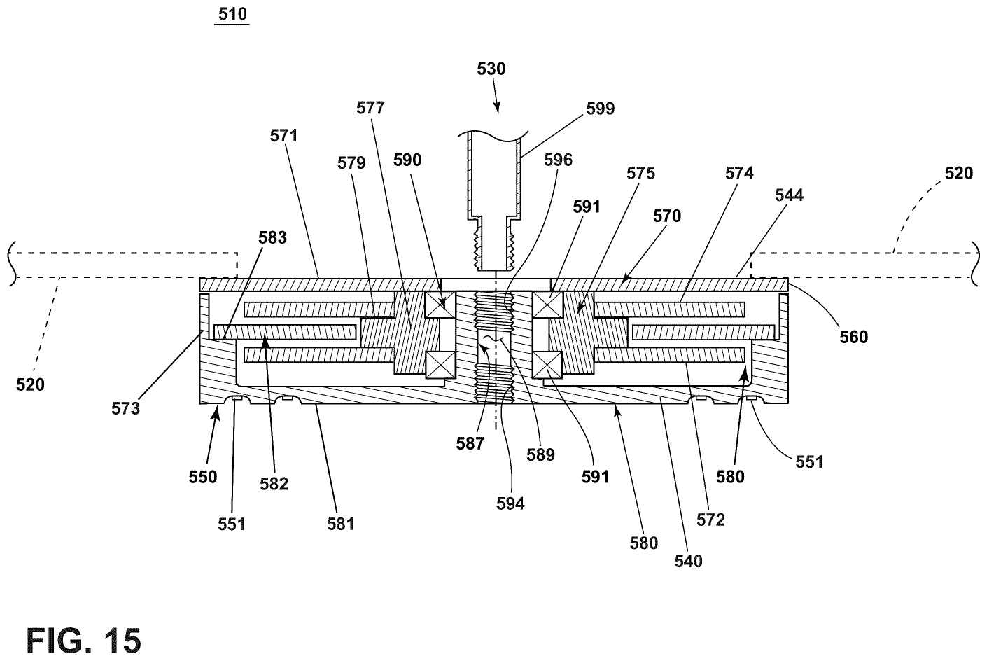

In another variant, as seen in FIG. 15, a ceiling fan 510 with motor 530. The ceiling fan 510 is similar to the ceiling fans 10, 110, 210, 310, and 410; therefore, like parts will be identified with like numerals beginning with 500, with it being understood that the description of the like parts of the ceiling fan 10, 110, 210, 310, and 410 applies to the ceiling fan 510, unless otherwise noted. The motor 530 is essentially the same as the motor 430 except that the blade mount 560 extends from the upper wall 571 or is an extension of the upper wall 571, the peripheral wall can be replaced with a longer rim 583 that extends almost to the inner surface of the upper wall 571 with a seat 579 formed in the rim 583 to receive the PCB stator 582. In such a configuration, if the blades 520 are mounted to the bottom of the blade mount 560, the blades would at least partially visually hide any gap between the rim 583 and the upper wall 571. The configuration of FIG. 15 can be applied to any of the motors described herein.

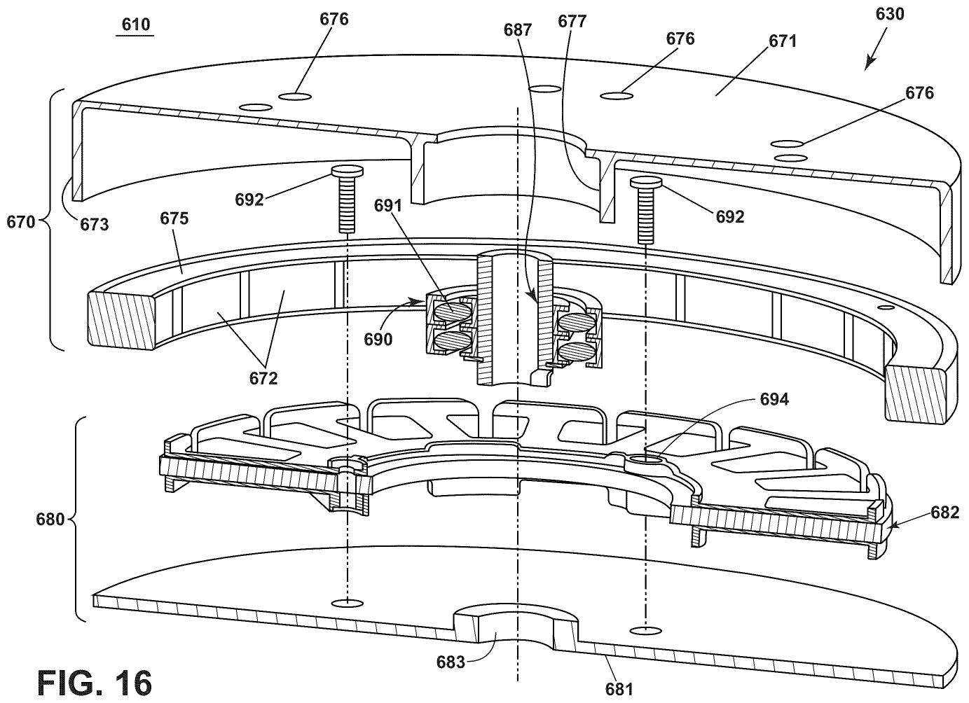

FIG. 16 illustrates another variant of a ceiling fan 610, with a low-profile motor 630. The ceiling fan 610 is similar to the ceiling fans 10, 110, 210, 310, 410, and 510; therefore, like parts will be identified with like numerals beginning with 600, with it being understood that the description of the like parts of the ceiling fan 10, 110, 210, 310, 410, and 510 applies to the ceiling fan 610, unless otherwise noted. The motor 630 differs from the other motors is that it is a radial flux motor, as compared to an axial flux motor, and it uses wire-wound coils (not shown for clarity) in the stator, instead of coils printed as traces on a PCB stator. The motor 630 includes a rotor assembly 670 and a stator assembly 680, which are relatively rotationally coupled by a bearing assembly 690.

The rotor assembly 670 includes an upper wall 671, with a collar 677, and a peripheral wall 673. A set of permanent magnets 672 are carried by one or both of the upper wall 671 and peripheral wall 673. As illustrated, the permanent magnets 672 are discrete magnets arranged in an annular cage 675 to form an annular ring that abuts the peripheral wall 673.

The permanent magnets 672 can be of any type or suitable shape. Back iron can be provided with the magnets to increase the magnetic field. The annular cage 675 can be any suitable structure to hold the magnets.

The stator assembly 680 includes a lower wall 681 and a stator core 682, which is supported by the lower wall 681, and a stationary motor shaft 687, which is secured to or integrally formed with the lower wall 681. The lower wall 681 includes a collar 683, which, as illustrated, receives the motor shaft 687. The motor shaft 687 can be attached to the collar 683 by press-fitting the motor shaft 687 into the collar 683, threading the motor shaft 687 into the collar 683, or any other suitable connection. When threaded, the collar 683 would be internally threaded and the shaft would be externally threaded, as illustrated, but the motor shaft 687 could just as easily be thread onto the exterior of the collar 683.

The stator core 682 comprises a core 685 with multiple posts 689 about which wire is wound to form a coil, which forms a pole for the stator core 682. The wound wire forming the coil is not shown for clarity. The stator core 682 is affixed to the lower wall 681 in any suitable manner. As illustrated, fasteners, such a bolts 692, pass through corresponding bosses 694 in the stator core 682 and thread into the lower wall 681.

Blades can be mounted to the rotor assembly 670 in the same manner as described for any of the other embodiments. For example, the blades can be directly fastened to the upper wall 674, which does have tapped openings 675 for such a purpose. Alternatively, as with any of the other embodiments, a blade iron or similar blade mount structure can be secured to the upper wall 671 or peripheral wall 673 and the blades attached to the blade iron or blade mount 660. For example, the blade mounts described for FIG. 13 can easily be used for the motor 630.

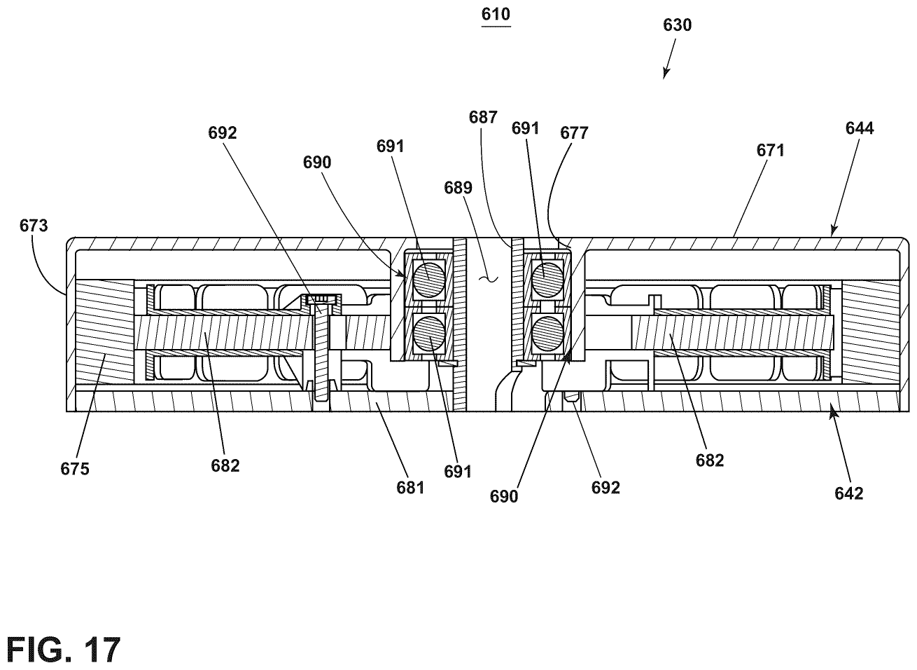

Referring to FIG. 17, the motor 630 is shown assembled where it can be seen that the bearing assembly 690 includes a pair of bearings 691 that encircle the motor shaft 687 and located between the motor shaft 687 and the collar 677. The gap between the exterior of the motor shaft 687 and the interior of the collar 677 can be controlled such that the bearings 691 are pressed between the collar 677 and the motor shaft 687. The motor shaft 687 can have a stop that limits the axial position of the bearings on the motor shaft 687. As illustrated, a snap-ring is attached to a lower portion of the motor shaft 687 and functions as an axial stop.

The bearings 691 are axially spaced from one another and/or span a sufficient axial distance along the motor shaft 687 such that they retard the wobbling of the rotor assembly 670 relative to the motor shaft 687 and/or the stator assembly 680, which enables tighter tolerances between the peripheral wall 673 and the periphery of the lower wall 681, which negates the need for a decorative motor housing, and, instead, use the motor itself.

The radial flux motor 630 has an advantage over the axial flux motors previously described when it comes to having a low profile and that advantage is attributable to the permanent magnets being radially aligned with the stator coils, instead of being vertically arranged as in the axial flux motors. However, the axial flux motors have an advantage in that the PCB stator, all things being equal, is not as tall as the stator coils. The combined thickness, including the spacing between the PCB stator and its permanent magnets will be less than the height of the stator coils for the radial flux motor 630. The axial flux motors also have the advantage in that the permanent magnets are affixed to the bearing assembly whereas in the radial flux motor, the permanent magnets are carried at the outer periphery of the rotor assembly, which creates a larger suspended mass, and a larger inertia. For a given output (watts or horsepower) motor, the PCB stator motor should yield a lower profile.

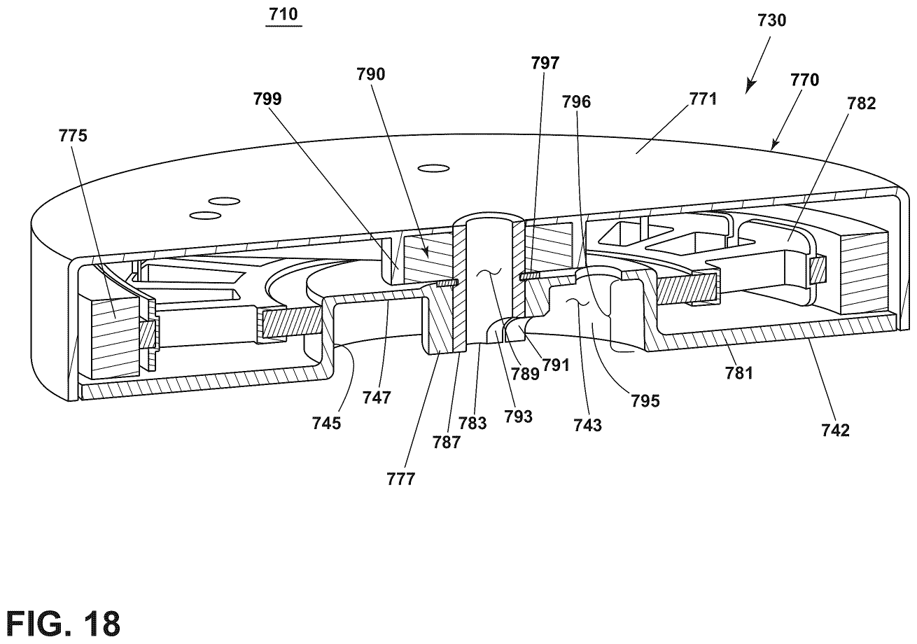

FIG. 18 illustrates another fan 710 having a variant DC, radial flux, motor 730. The ceiling fan 710 is similar to the ceiling fans 10, 110, 210, 310, 410, 510, and 610; therefore, like parts will be identified with like numerals beginning with 700, with it being understood that the description of the like parts of the ceiling fan 10, 110, 210, 310, 410, 510, 610 applies to the ceiling fan 710, unless otherwise noted. More specifically, the motor 730 is essentially identical to motor 730, except that the stator or lower housing 742 defines a recess 743, which can be used to receive one or more module/accessory for the fan, such as a fan controller (typically in the form of a PCB), a light kit, a remote-control unit, and/or another other desired accessory. As illustrated the recess is formed by a circular peripheral wall 745, which can also be used to support the stator, especially the cage for the stator coils or permanent magnets if the stator were to use them. The recess 743 is further illustrated as being formed by a top wall 747, from which a collar 777 depends, with the collar 777 receiving and securing the motor shaft 787 by means of a snap ring 797 received within a channel on the outer surface of the motor shaft 787 and resting on the collar 777.

The motor shaft 787 has a hollow interior 789. Complementary and aligned openings 791 and 793 are formed in the collar 777 and motor shaft 787 and permit electrical wires to pass from the recess 743 into the hollow interior 789, which can be used to provide power or data to anything stored in the recess 743. Such pass-through openings 791, 793 can be used in any of the disclosed motors, even those without a recess.

As illustrated, the motor shaft 787 and collar 777 do not extend down to the same vertical extent as the lower wall 781, which provides an uninterrupted space 795 within the recess 743. The rest of the recess 743 has an annular shape 796. Modules for the ceiling fan, such as remote control modules, wireless modules, light kits, PCBs, including the fan controller or motor controller, or both, can be formed in an annular or donut-like shape and received within the recess 743 above the uninterrupted space 795. Alternatively, they can be formed to fit withing the uninterrupted space 795. Multiple modules can fit within the recess. One or more can be donut-shaped, say, for example, a fan controller on a PCB, and another could be a light kit, say a plurality of LEDs placed within the uninterrupted space 795.

The recess 743 can be formed in any of the described motors. The recess provides yet one more way in which the stack height, S, of the motor can be reduced for a lower profile. The recess 743, as illustrated, extends at least partially within at least one of the coils/magnets for the stator/rotor. In this sense, the recess is at least partially located within the vertical extent of the coils/magnets of the stator/rotor and can be fully located within the vertical extent.

The rotor assembly 770 includes a top wall 771 in which is defined a bearing seat formed by an annular wall 799 in combination with the top wall 771 in which a single bearing 790 is received to rotationally secure the rotor 770 to that stationary motor shaft 787 is received. The snap ring 797 also can aid in positioning the bearing 790 within the bearing seat. The bearing seat can be sized such that the outer race of the bearing 790 is pressed within the bearing seat and bears against the annular wall 799 and the motor shaft 787 is pressed within the inner race of the bearing 790.

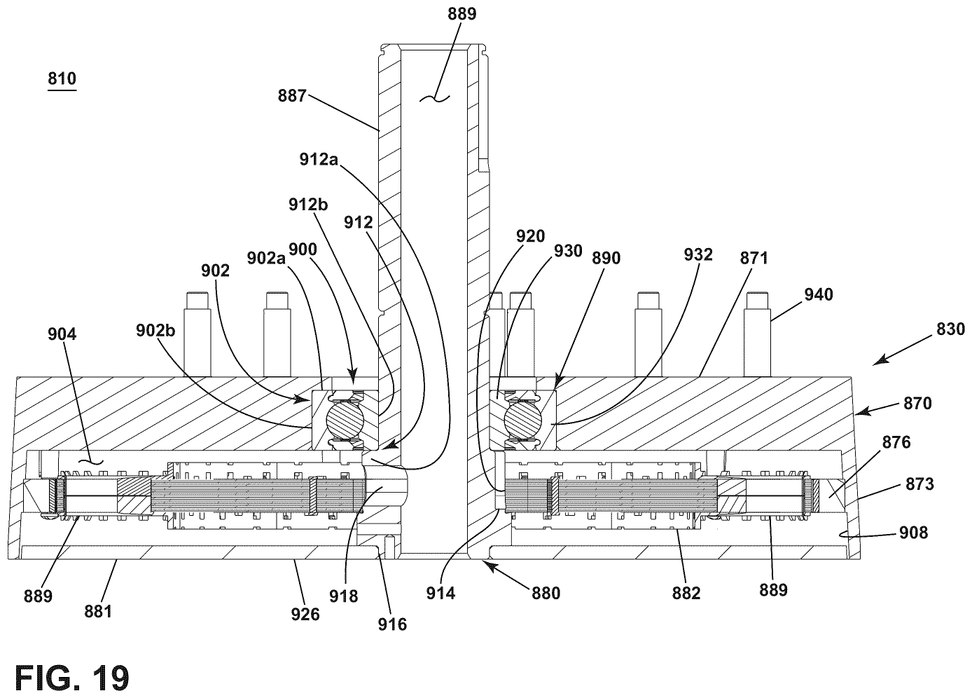

FIG. 19 illustrates another fan 810 having a variant DC, radial flux, motor 830. The ceiling fan 810 is similar to the ceiling fans 10, 110, 210, 310, 410, 510, 610, and 710; therefore, like parts will be identified with like numerals beginning with 800, with it being understood that the description of the like parts of the ceiling fan 10, 110, 210, 310, 410, 510, 610, 710 applies to the ceiling fan 810, unless otherwise noted.

The motor 830 comprises a rotor assembly 870 rotationally coupled to a stator assembly 880 by a bearing assembly 890 and a stationary motor shaft 887. The bearing assembly 890 rotationally couples the rotor assembly 870 to the motor shaft 887. The motor shaft 887 provides a securing structure for many elements of the stator assembly 880.

The rotor assembly 870 is illustrated with a top wall 871 from which extends a peripheral wall 873. A shaft opening 900 is formed in the top wall 871. An outer bearing seat 902 circumscribes the shaft opening 900 and is illustrated as a recess formed in the thickness of the top wall 871. However, other structures, such as a depending wall, could be used in place of the recess, especially when the top wall 871 is not as thick as illustrated. The outer bearing seat 902 comprises a lip 902a and a peripheral wall 902b.

The peripheral wall 873 extends below the top wall 870 and defines in interior 904 in which all or a portion of the stator assembly 880 can be received. The peripheral wall 873 has an inner surface 908 on which is provided a magnet seat 910 supporting a plurality of magnets 876, such as permanent magnets. The magnet seat 910 is illustrated as a ledge or step in the inner surface 908 and the magnets 876, which form a ring, can be pressed into the step. However, the magnets 876 can be mounted to the magnet seat 910 in any manner desired.

The peripheral wall 873 is slightly tapered relative to the vertical in that it has a decreasing diameter as it extends in height. However, the taper is not material and the peripheral wall 873 need not have taper at all or could have the opposite taper as illustrated. The taper does provide for the formation of the step for the magnet seat 910 while still maintaining a general overall thickness for the peripheral wall 873.

The stationary motor shaft 887 has a hollow interior 889, which extends through the entire length of the motor shaft 887, although it need not do so to perform its function. An inner bearing seat 912 is formed on the exterior of the motor shaft 887 and is illustrated as a collar or ledge 912a and a peripheral wall portion 912b of the motor shaft 887, which amounts to a local increase in the diameter of the motor shaft 887. Below the inner bearing seat 912 is a stator mounting seat 914 also in the form of a ledge or collar and provides a surface against which the stator can rest or abut.

The stationary motor shaft 887 terminates at a lower end in a neck 916, which can have external threads. As illustrated, the neck 916 can be seen as an undercut to the collar forming the inner bearing seat 912.

A passage 918 extends through the collar forming the inner bearing seat 912. The passage establishes communication between the hollow interior 889 and the interior 904, thereby creating a path through the hollow interior 904, through the passage 918 to the stator assembly 880. Electrical wiring, such as for power or data, can pass along this path, which can be used to supply power or data to the stator or to any nearby accessory. While the passage 918 is shown extending through the collar forming the inner bearing seat 912, the passage need not be so located. The passage could be located anywhere along the length of the motor shaft 887. There also can be multiple passages.

The stator assembly 880 comprises an annular core 885 with a central opening 920 defining an edge that rests on the stator mounting seat 914. The core 885 includes multiple posts 889 about which wires can be wound to form electrical windings for the stator assembly 880. The windings can be supplied electrical power by wiring passing through the hollow interior 889 and passage 918.

The stator assembly also includes a closure 881 to close the open end of the rotor assembly 870 and cover the interior 904. The closure 926 can be of any shape and is illustrated as a disc with a central aperture, which can be threaded to thread onto the neck 916 of the motor shaft 887. However, the disc could also be pressed on or attached in other ways. The closure 881 can also be a light assembly, such as a disc with one or more sources of illumination, such as an array of LED lights, which are supplied electrical power by wires passing through the hollow interior 889 and/or the passage 918. If the closure 881 is a light assembly, it can also include a globe or similar translucent or transparent cover over the illumination sources.

The bearing assembly 890 comprises an inner race 930 and an outer race 932, with a plurality of rollers or bearings 934 located between the inner race 930 and outer race 932. The inner race 930 seats within the inner bearing seat 912 and the outer race 932 seats within the outer bearing seat 902.

More specifically, the inner race 930 sits on the ledge 912a and bears against the portion of the peripheral wall 912b of the motor shaft 887. The ledge 912a functions as a stop to limit the axial movement and position of the inner race 930 along the motor shaft 887. The outer race 932 catches the lip 902a and bears against the wall 902b.

When assembling the bearing assembly 890 to the motor shaft 887, the bearing assembly 890 can be sized such that the inner race is press-fitted onto the motor shaft 887 as it abuts the ledge 912a. Similarly, the outer race 932 is press-fitted into the recess formed by the peripheral wall 902b and the lip 902a of the outer bearing seat 902.

Most ceiling fan motors use a pair of axially spaced bearing assemblies to rotationally mount the rotor assembly 870 to the motor shaft 887 because the axial spacing provides two spaced contact points that reduce the tendency of the rotor assembly from wobbling as it would if there was only a single bearing with a single contact point. However, the two axially spaced bearings increase the height of the motor, which is not desirable in low profile configurations. A single bearing assembly 900 can be used and still prevent the wobbling about the single contact point because the bearing assembly 900 is in substantially full contact with the rotor assembly 870 and the motor shaft 887. In other words, the substantial length or axial extent of the outer race 932 is in abutting contact with the peripheral wall 902b and the substantial length or axial extent of the inner race 930 is in contact with the portion 912b of the motor shaft 887. This “full extent” contact makes it possible for a single bearing to be used in a ceiling fan environment as compared to multiple bearings.

For completeness, a plurality of mounting bolts 940 extend from the rotor assembly 870 and can be used to secure blades to the rotor housing. The mounting bolts 940 are just one structure for securing the blades to the rotor and the particular structure for mounting the blades is not germane to the motor. Any suitable mounting structure can be used.

It should be noted that for all of the described motors, the stator is illustrated as having windings, be it in the form of a winding printed on a PCB for the PCB stator or as a wound coil of wire in the radial flux, not permanent magnets, and the rotor is illustrated as having permanent magnets. The windings and permanent magnets form the various magnetic poles of the motor used for rotation of the rotor relative to the stator. It is within the scope of the disclosure for the windings and permanent magnets to be switched and the stator have the permanent magnets and the rotor have the windings. It can be appreciated that in an alternative, the rotor can comprise the PCB (PCB rotor) and the stator comprises the upper and lower sets of permanent magnets. For such a configuration, it would be beneficial for the blades to be coupled to an upper or lower housing instead of directly to the PCB rotor. It can further be appreciated that in another alternative, the rotor comprises the coil windings and the stator comprises the outer periphery of magnets. For such a configuration, the blades could be coupled to an upper or lower portion of the coil winding assembly. Further, all of the described motors are direct current or DC motors. However, AC motors could be used.

All of the previously described motors have a structure and arrangement of parts that will yield a low profile motor. A subset of the previously described motors, those without a motor housing and with the blades located between the upper/lower walls of the rotor and stator, will yield a lower profile where the stack height is one and the same as the motor height, which is possible motors with and without lights, especially when the lights are part of at least one of the walls of the motor, such as the embedded LEDS of FIGS. 13-18.

The performance characteristics of the motor in the ceiling environment do impact the stack height. The power (watts or horsepower) of the motor and/or its torque will dictate, to some extent, the size and arrangement of the permanent magnets and/or coils needed to accelerate the motor at a desired rate and/or rotate the motor at a desired speed. The acceleration and/or rate of rotation are a function of desired airflow, which is a function of the blade shape, length, and mass. Assuming it is desired to maintain the blades within a certain vertical height relative to the fan, say within the stack height, at some point the blades will be too long and they will sag below the stack height. The rotation and lift forces acting on the blade may raise them some during operation, but there is a practical limit for any given limitation. Also, as the blades get longer, they have more mass, and the additional mass will impact acceleration, and more torque is needed to maintain a certain speed for a given airflow rate. For a desired stack height of 1-3 inches, the motor can have a width of 4.8 to 14.4 inches, a torque of 0.5-5 Nm (newton-meters), a motor height of 0.9 to 3 inches, a fan diameter of 30 to 96 inches (where the diameter is twice the distance from the rotational axis to a blade tip). Such ranges are very suitable for a ceiling fan.

Aspects of the disclosure provide for many other embodiments or implementations. For instance, a PCB can be provided with the rotor assembly, and magnetic plates can be provided with the stator assembly. In such a case, in one exemplary implementation, the upper and lower motor housings can each be rotatable with at least one PCB coupled thereto. The set of blades can be mounted directly to at least one of the upper motor housing and lower motor housing. During operation of the motor, the set of blades, the upper and lower motor housings, and at least one PCB can rotate while the magnetic plates remain stationary with the stator assembly.

Aspects of the disclosure provide for several benefits. The use of an axial flux motor provides for an ultra-lowprofile driving mechanism for the ceiling fan, which enables a lower overall stack height and a lower weight compared to fans with traditional motors. The reduction in stack height allows the fan to be positioned much closer to the ceiling or overhead surface, providing for a more compact form factor and improved safety in spaces with low ceilings. The scalloped portion of the blades described herein provides for improved aerodynamic performance with reduced need for overhead clearance of the fan. The snap-fit blade connection provides for improved access for assembly, disassembly, or servicing of the ceiling fan. The integral blade housing can provide for a streamlined assembly with reduced part complexity and shortened assembly times. The motor housing with integral heat sink can provide for cooling of the motor and the light kit, further reducing part complexity and assembly times, and also improving operating performance by dissipating heat during operation. Still another benefit is that the low-profile, lightweight motor provides for an improved consumer installation experience in securing the ceiling fan to an overhead surface.

Although aspects of the present disclosure have been shown and described, it would be appreciated by those skilled in the art that changes may be made in these aspects without departing from the principles and spirit of the disclosure. Although specific terms are employed herein, they are used in a generic and descriptive sense only and not for purposes of limitation.

This written description uses examples to disclose the disclosure, including the best mode, and to enable any person skilled in the art to practice the disclosure, including making and using any devices or systems and performing any incorporated methods. The patentable scope of the disclosure is defined by the claims, and can include other examples that occur to those skilled in the art. Such other examples are intended to be within the scope of the claims if they have structural elements that do not differ from the literal language of the claims, or if they include equivalent structural elements with insubstantial differences from the literal languages of the claims.

Further aspects of the disclosure are provided by the following clauses:

A ceiling fan including a motor housing, a set of blades extending from the motor housing, a light kit coupled to the motor housing, and a motor enclosed by the motor housing, with the motor comprising an axial flux motor with upper and lower rotatable magnetic plates stacked with a centrally-located stator.

The ceiling fan of any preceding clause, wherein the stator comprises a PCB stator extending radially beyond the rotor plates within the motor housing.

The ceiling fan of any preceding clause, wherein the motor housing includes a two-part assembly with an upper portion and a lower portion enclosing the upper and lower magnetic plates, respectively.

The ceiling fan of any preceding clause, wherein the blades are coupled to, and co-rotate with, the upper magnetic plate or the lower magnetic plate.

The ceiling fan of any preceding clause, wherein the blades are operably coupled to, and spaced from, one of the upper magnetic plate or the lower magnetic plate.

The ceiling fan of any preceding clause, further comprising a blade housing enclosing the motor housing.

The ceiling fan of any preceding clause, wherein the blades are rotatably coupled to the hub via an opening defined in the blade housing.

The ceiling fan of any preceding clause, wherein the blades extend radially outward above the motor housing.

The ceiling fan of any preceding clause, wherein the blades extend radially outward below the motor housing.

The ceiling fan of any preceding clause, further comprising a plurality of discrete blade mounts enclosed by the blade housing.

The ceiling fan of any preceding clause, further comprising an outer body, an impeller within the body, and a flow path defined between an inlet of the body and an outlet of the body.

The ceiling fan of any preceding clause, wherein an overall stack height of the ceiling fan is between 1.5-3 inches.

The ceiling fan of any preceding clause, wherein a height of the motor housing is between 1-2 inches.

The ceiling fan of any preceding clause, wherein a height of the motor housing is between 1.25-2 inches.

A ceiling fan comprising: a motor having a stator assembly, with a stationary motor shaft, and a rotor assembly; a bearing assembly rotationally coupling the rotor assembly to the motor shaft; a motor housing enclosing at least a portion of one of the stator assembly and rotor assembly; a plurality of blades coupled to the rotor assembly; wherein a stack height of the motor and motor housing is between 1.0 inches and 3 inches.

The ceiling fan of any preceding clause wherein the motor housing is integrally formed with at least one of the stator assembly and rotor assembly.

The ceiling fan of any preceding clause wherein the blades are coupled to the rotor assembly within the stack height.

The ceiling fan of any preceding clause wherein the blades are completely located within the stack height.

The ceiling fan of any preceding clause wherein the motor has a width of 4.8 to 14.4 inches.

The ceiling fan of any preceding clause wherein the motor has a torque of 0.5 to 5 Nm.

The ceiling fan of any preceding clause wherein the motor has a height of 0.9 to 3.0 inches.

The ceiling fan of any preceding clause wherein the height is 1-2 inches.

The ceiling fan of any preceding clause wherein the fan has a diameter of 30 to 96 inches.

The ceiling fan of any preceding clause wherein: the motor has a width of 4.8 to 14.4 inches; the motor has a torque of 0.5 to 5 Nm; the motor has a height of 0.9 to 3.0 inches; and the fan has a diameter of 30 to 96 inches.

The ceiling fan of any preceding clause wherein the stator assembly comprises a PCB stator.

The ceiling fan of any preceding clause wherein the rotor assembly comprises two sets of permanent magnets, with one set located above the PCB stator and the other set located below the PCB stator.

The ceiling fan of any preceding clause wherein the stator assembly comprises a PCB stator.

The ceiling fan of any preceding clause wherein the rotor assembly comprises two sets of permanent magnets, with one set located above the PCB stator and the other set located below the PCB stator.

The ceiling fan of any preceding clause wherein the stator assembly comprises a lower wall supporting the PCB stator.

The ceiling fan of any preceding clause wherein the stationary motor shaft extends from the lower wall.

The ceiling fan of any preceding clause wherein the lower wall comprises a rim supporting the PCB stator.

The ceiling fan of any preceding clause wherein the rotor assembly comprises a carriage coupling to the bearing assembly.

The ceiling fan of any preceding clause wherein the carriage supports the sets of permanent magnets.

The ceiling fan of any preceding clause further comprising a light kit carried by the stator assembly and the light kit is located within the stack height.

The ceiling fan of any preceding clause wherein the stator comprises a lower wall and the light kit is integrated into the lower wall.

What is claimed is:

1. A ceiling fan comprising:
a set of blades extending between a root and a tip;
a motor assembly comprising:
a stator assembly comprising a stationary motor shaft and a stator coupled to the stationary motor shaft,
a rotor assembly comprising a rotor operably coupled to the root of the blades, and
a bearing assembly having a single bearing rotationally coupling the stationary motor shaft to the rotor assembly.

2. The ceiling fan of claim 1 wherein rotor assembly and the stationary motor shaft collectively define a bearing seat in which the single bearing resides.

3. The ceiling fan of claim 2 wherein the rotor comprises a first wall and a peripheral wall extending from the first wall, the rotor comprises a second wall, axially spaced from the first wall along the stationary motor shaft to define an interior at least partially bounded by the first wall, second wall, and peripheral wall, and the bearing seat is located within the interior between the first wall and the second wall.

4. The ceiling fan of claim 3 wherein the stationary motor shaft does not extend beyond the first wall.

5. The ceiling fan of claim 4 wherein the stationary motor shaft does not extend beyond the second wall.

6. The ceiling fan of claim 5 wherein the second wall at least partially defines a light kit.

7. The ceiling fan of claim 6 wherein the light kit comprises a plurality of light emitting diodes (LEDs) carried by the second wall.

8. The ceiling fan of claim 7 wherein the second wall defines an accessory recess.

9. The ceiling fan of claim 3 wherein the first wall comprises an annular wall located within the interior and partially defining the bearing seat.

10. The ceiling fan of claim 9 wherein the annual wall depends from the top wall and circumscribes the stationary motor shaft.

11. The ceiling fan of claim 10 wherein the annular wall depends a length as least as great as the single bearing such that the annular wall abuts the entire axial length of the single bearing.

12. The ceiling fan of claim 11 wherein the stationary motor shaft abuts the entire axial length of the single bearing.

13. The ceiling fan of claim 12 wherein the annular wall abuts an outer surface of the single bearing and the stationary motor shaft abuts an inner surface of the single bearing.

14. The ceiling fan of claim 13 further comprising a snap-ring attached to the stationary motor shaft and abutting a first axial end of the single bearing.

15. The ceiling fan of claim 14 wherein a second axial end of the single bearing abuts the first wall.

16. The ceiling fan of claim 3 wherein the peripheral wall axially overlaps at least a portion of the second wall.

17. The ceiling fan of claim 16 wherein the rotor comprises a plurality of circumferentially spaced permanent magnets carried by the peripheral wall.

18. The ceiling fan of claim 17 wherein the permanent magnets are located within the interior.

19. The ceiling fan of claim 18 wherein the stator comprises a core carried by the stationary motor shaft and having a plurality of circumferentially spaced windings confronting the permanent magnets.

20. The ceiling fan of claim 19 wherein the blades are mounted to the first wall.
